(19) United States
(12) Patent Application Publication
(10) Pub. No.: US 2009/0267309 A1
(43) Pub. Date: Oct. 29, 2009

(54) FLAT SEAL HAVING A DEFORMATION LIMITER

(76) Inventor: Jan Mueller, Neunkirchen (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/444,276

(22) PCT Filed: Jun. 27, 2007
(86) PCT No.: PCT/EP2007/005687

§ 371 Date: Apr. 3, 2009

(30) Foreign Application Priority Data
Oct. 6, 2006 (DE) 10 2006 047 424.4

(51) Int. Cl. F02F 11/00

(52) U.S. Cl. 277/592

(57) ABSTRACT

A flat seal having at least one metallic layer is disclosed, wherein the at least one metallic layer at least partially comprises a profile having an undulated structure in the cross-section on the side of the metallic layer. The profile on the side opposite of the undulated structure has a contour in which rounded sections and those provided with edges alternate.

The present invention relates to a flat seal with at least one metallic layer and in particular to a metallic layer of a flat seal which is used as a deformation limiter. The metallic flat seal can be used in particular as a cylinder head seal, as used for sealing off components in internal combustion engines, but can also be configured for other types of seal such as flange seals.

A cylinder head seal is clamped between the engine block and the cylinder head in an internal combustion engine system. Its main task is sealing off the combustion chamber, the oil ducts and the coolant regions. It is moreover used as a force transmission member between cylinder head and cylinder block. Sealing gap vibrations which occur when the engine is running must be compensated elastically.

In order to ensure or increase the sealing effect of a cylinder head seal, in particular in regions of the cylinder head seal around through-openings, for example combustion chamber openings or coolant and engine oil passages, at least one layer of the cylinder head seal is generally provided with beading or projections, which generally completely surround these openings. The required elasticity of the cylinder head seal is also ensured by the beading or projections.

The elastic deformability of the beading depends essentially on the stiffness of the component, that is, the beading is deformed more or less depending on the stiffness of cylinder head and engine block. This elastic property of the beading decreases over time, however. Excessive sealing gap vibrations can additionally lead to overloading of the beading. It can result in reduction of beading strength and of resilience potential or even cracks in the beading. For this reason, deformation limiters are currently customarily used, which are also called “stoppers” or “INSTOP”. With these, a complete plastic deformation is prevented and optimum conditions with regard to durability and resilience behaviour are achieved. These deformation limiters can be achieved for example by bending one of the metallic layers over, or further stopper layers are inserted between the functional layers of the seal.

EP 1 290 364 discloses what are known as wave stoppers and what are known as trapezoidal stoppers. Wave stoppers are metallic layers into which a wave shape is impressed, and trapezoidal stoppers are wave stoppers in which the respective wave peaks and troughs are flattened or levelled. The wave stoppers and trapezoidal stoppers are characterised by the fact that they adapt ideally to the given tension, temperature and stiffness conditions and in the process utilise the given installation space optimally.

The wave stopper has a large and variable range of elasticity owing to its wave-like shape. The wave stopper can be adapted to the given engine stiffness by varying the parameters of the wave stopper such as height of the metallic layer, amplitude of the impressed wave shape and radius of the impressed wave shape. This behaviour means that the compression peaks during each operating state are equalised and compressions on the components are harmonised.

In order to be able to reduce the compression amplitude of the surface pressure, what is known as a trapezoidal shape was developed in addition to the wave shape. This modified wave stopper has a distinct elastic-plastic behaviour with at the same time reduced surface pressure. The bearing face can be adapted and distributed according to the requirements.

The object of the present invention is therefore to provide a stopper which combines the advantages of a wave stopper and those of a trapezoidal stopper.

According to the invention, a contour is specified which has sections, which are provided with edges and rounded off, and which can be matched very variably to the corresponding pressure and sealing conditions. The stopper according to the invention behaves in the actual working region more stiffly than a wave stopper and thus fulfils its function of replacing the welded stopper even better. A further advantage of the contour of the stopper according to the invention is that the tool which was previously used for impressing a wave stopper can continue to be used. This means a cost-effective solution is obtained.

According to a first aspect of the present invention, a flat seal is provided, having at least one metallic layer, with the at least one metallic layer having at least partially a profile. The profile is for example impressed into the metallic layer and has a wave-shaped structure on one side of the metallic layer, as seen in cross section. The profile is characterised in that the side which lies opposite the wave-shaped structure has a contour in which sections which are provided with edges and rounded sections alternate. The wave-shaped structure and the rounded elements of the contour do not necessarily have to have a sinusoidal shape, other wave shapes are also possible. Furthermore, the sections of the contour which are provided with edges are not limited to the number of edges or certain angles. The combination of the wave-shaped structure and the contour produces a different deformation behaviour from stoppers which are rounded on both sides. This increases the stiffness of the stopper according to the invention.

The at least one metallic layer preferably has beading adjacent to the profile. This arrangement means that the profile according to the invention can act as a deformation limiter or stopper for the beading, even when the flat seal only consists of one layer.

The height of the profile, which is composed of the amplitude of the wave-shaped structure and the height of the contour, is preferably smaller than the height of the beading. This ensures that the full sealing effect of the beading is maintained.

In one exemplary embodiment, the wave peaks of the wave-shaped structure and/or the rounded sections of the contour have uniform spacing. This means that the pressure distribution on the cylinder head or engine block can be kept uniform.

In a further exemplary embodiment, the wave peaks of the wave-shaped structure and/or the rounded sections of the contour have different spacing. This means that the stopper can be adapted to the respective requirements on the flat seal. Elasticity and spring stiffness of the flat seal can in particular be adjusted locally and individually.

The wave peaks of the wave-shaped structure and the rounded sections of the contour preferably align essentially perpendicularly to the metallic layer. This means that the material cross section at the point of the metallic layer at which the wave peaks of the wave-shaped structure or the rounded sections are located is thicker than the same point in a pure wave stopper. This results in an increased stiffness of the flat seal.

According to a further embodiment, the profile height varies within the profile. This means that the amplitude of the wave-shaped structure and the height of the rounded sections within the profile can be adapted individually to the respective geometry of the flat seal and the surrounding engine parts. This allows the elasticity of the flat seal and the spring stiffness to be influenced locally.

According to a further aspect, the flat seal has a further metallic layer with a similar profile to the first metallic layer. This means that certain thickness ratios and pressure ratios can be taken into account within the flat seal.

The further metallic layer is preferably arranged mirror-symmetrically to the first metallic layer. This means that the favourable properties with regard to elasticity and stiffness of the flat seal are retained. Beading can also be saved owing to the two metallic layers with the profiles and nevertheless the desired sealing effect with sufficient clamping force can be retained. In this case the bearing face of the stopper on the adjacent sealing layers or the adjacent engine parts, the elasticity and the stiffness of the stopper increase, depending on the orientation of the two layers.

According to a further embodiment, the profile of the first metallic layer and the profile of the further metallic layer are arranged offset with respect to each other. This means that the sealing behaviour can be further influenced in a targeted manner.

The two metallic layers can have different profiles. The two layers can be different in terms of their length, depth, amplitude, angle, the spacing of their wave-shaped structure and the height, angle, radius, number of edges and the spacing of the rounded sections of the contour. This means that the pressure profile of a flat seal can be designed individually with respect to individual requirements and conditions.

At least one of the metallic layers is preferably produced from elastic spring steel. However, any other suitable material can be used, for example a steel which can be cold-deformed and hardens on tempering.

Of course, further layers which contain a stopper with the profile according to the invention can be introduced into the flat seal.

The present invention will now be described in more detail using drawings of different embodiments of the invention.

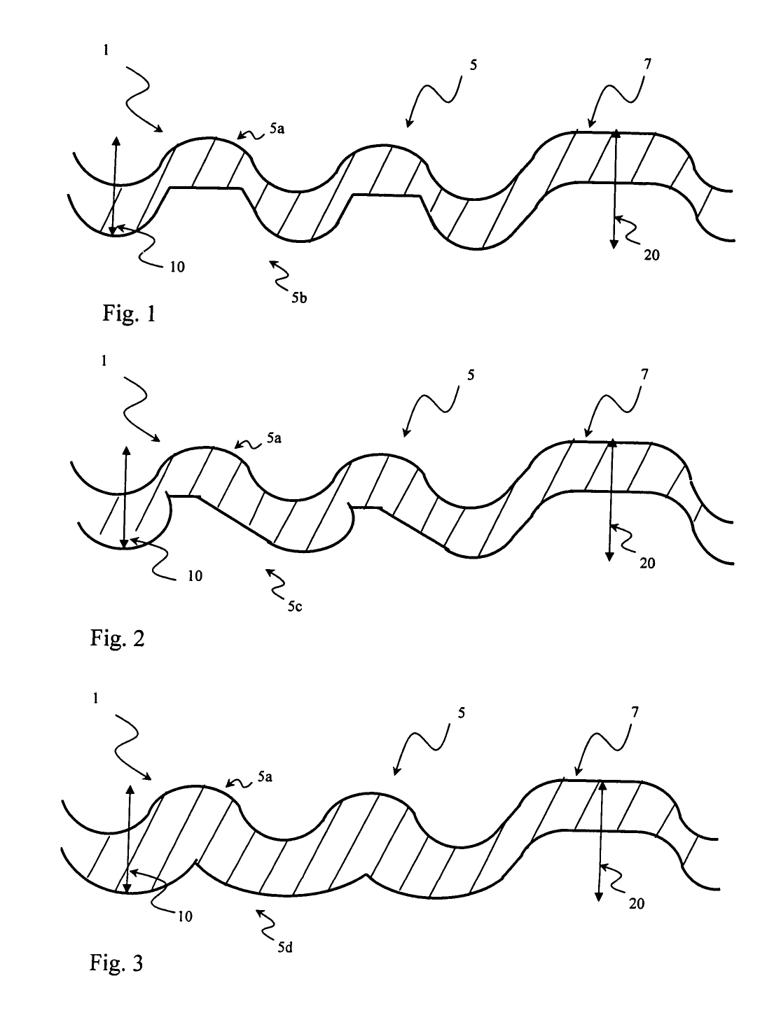

FIG. 1 shows a schematic lateral sectional view through part of a flat seal with a profile according to the invention, which profile acts as a stopper for beading.

FIG. 2 shows a schematic lateral sectional view through part of a flat seal with a further profile according to the invention, which profile acts as a stopper for beading.

FIG. 3 shows a schematic lateral sectional view through part of a flat seal with a further profile according to the invention, which profile acts as a stopper for beading.

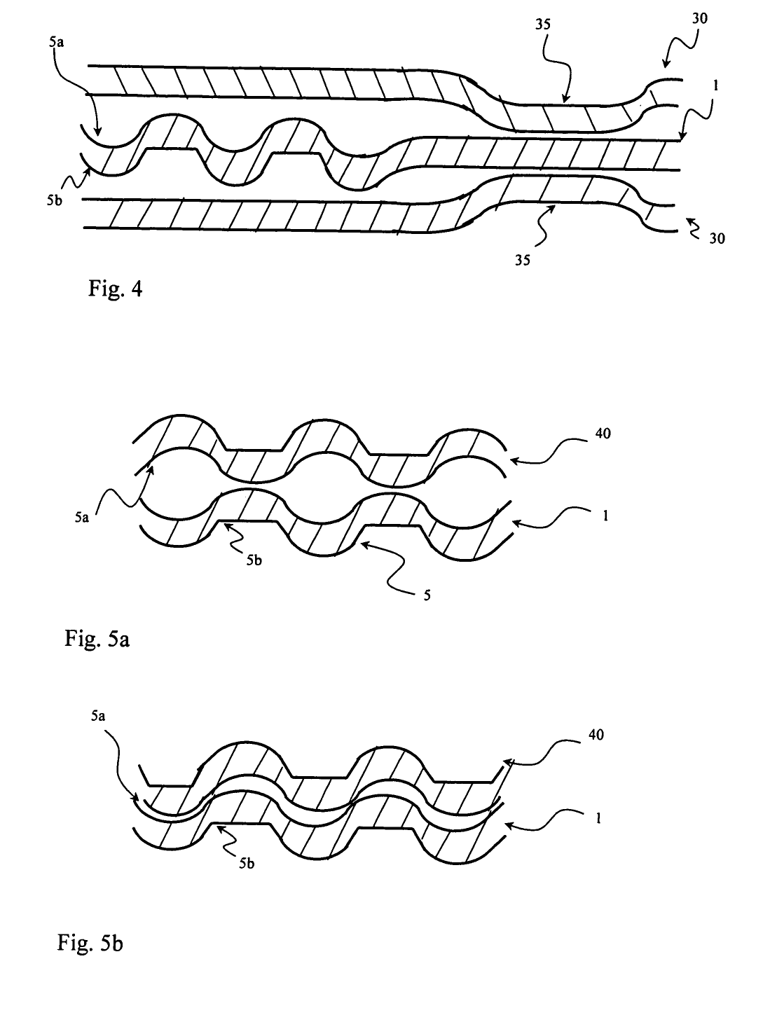

FIG. 4 shows a schematic lateral sectional view through part of a three-layered flat seal.

FIGS. 5a and 5b in each case show a schematic lateral sectional view through part of a flat seal with two layers with the profile according to the invention.

FIG. 1 illustrates a detail of a metallic layer 1 in a flat seal. A profile 5 is impressed as a stopper into the metallic layer, which profile has a wave-shaped structure 5a on one side and a contour 5b on the other side, which contour consists of a wave-shaped structure in which bottoms of the wave troughs are flattened. The height 10 of the profile extends between the amplitude of the wave-shaped structure and the amplitude of the wave peaks of the contour. Beading 7 is arranged adjacent to the stopper, which beading has a height 20. This height 20 of the beading is greater than the height 10 of the profile. The beading does not necessarily have to be impressed into the metallic layer in the same direction as the wave-shaped structure, it can also extend in the direction of the contour.

FIG. 2 shows a schematic lateral sectional view through part of a flat seal with a further embodiment of the profile according to the invention. The metallic layer 1 of the flat seal has a profile 5. The profile 5 comprises a wave-shaped structure 5a and a contour 5c in which asymmetrical sections which are provided with edges and asymmetrical, rounded sections alternate. The height 10 of this profile extends between the amplitude of the wave-shaped structure and the height of the rounded sections. Beading 7 with a height 20 is arranged adjacent to the stopper. The height 10 of the profile is less than the height of the beading 20.

FIG. 3 shows a schematic lateral sectional view through part of a flat seal with a further embodiment of the profile according to the invention. As in FIGS. 1 and 2, a metallic layer 1 has a profile 5. The profile in this case comprises in addition to the wave-shaped structure 5a a contour 5d in which the rounded sections in each case meet in an edge in the centre of the wave peaks of the wave-shaped structure. Beading 7 is adjacent to the profile in this case too. The height 10 of the profile, which extends from the amplitude of the wave-shaped structure to the height of the rounded sections of the contour, is less than the height of the beading 7 in this case too.

FIG. 4 shows a schematic lateral sectional view through part of a three-layered flat seal. The two outer-lying layers 30 in each case have beading 35. A metallic layer 1 with the profile according to the invention is arranged between the two beaded layers. The metallic layer 1 acts as a stopper for the two beaded layers 30. To this end, a profile is impressed as a stopper into the metallic layer 1, which profile has a wave-shaped structure 5a on one side and a contour 5b on the other side, which contour consists of a wave-shaped structure in which bottoms of the wave troughs are flattened.

FIG. 5a shows part of a flat seal with two metallic layers 1 and 40. The two layers both have the profile 5 according to the invention with the wave-shaped structure 5a on one side and the contour 5b which consists of a wave-shaped structure in which bottoms of the wave troughs are flattened, on the other side. The two layers are arranged mirror-symmetrically so that the wave peaks of the layer 40 come to lie upon the wave peaks of the layer 1.

FIG. 5b shows two metallic layers 1 and 50, which form part of a flat seal. Both layers have the profile 5 according to the invention with the wave-shaped structure 5a on one side and the contour 5b on the other side. Although the two layers are arranged mirror-symmetrically, in contrast to FIG. 5a the two layers are in this case offset with respect to each other so that the wave peak of layer 50 comes to lie in the wave trough of layer 1.

1. A flat seal with at least one metallic layer, with the at least one metallic layer having at least partially a profile which has a wave-shaped structure on one side of the metallic layer, as seen in cross section, and wherein the profile of the side which lies opposite the wave-shaped structure has a contour in which angled and rounded sections alternate.

2. The flat seal according to claim 1, wherein the at least one metallic layer has beading adjacent to the profile.

3. The flat seal according to claim 2, wherein the height of the profile is less than the height of the beading.

4. The flat seal according to claim 1, wherein the wave peaks of the wave-shaped structure have at least partially uniform spacing.

5. The flat seal according to claim 1, wherein the wave peaks of the wave-shaped structure have at least partially different spacing.

6. The flat seal according to claim 1, wherein the rounded sections of the contour have at least partially uniform spacing.

7. The flat seal according to claim 1, wherein the rounded sections of the contour have at least partially different spacing.

8. The flat seal according to claim 1, wherein the wave troughs of the wave-shaped structure and the rounded sections of the contour align essentially perpendicularly to the metallic layer.

9. The flat seal according to claim 1, wherein the profile height varies within the profile.

10. The flat seal according to claim 1, wherein a further metallic layer is provided which has a similar profile to the first metallic layer.

11. The flat seal according to claim 10, wherein the further metallic layer is arranged mirror-symmetrically to the first metallic layer.

12. The flat seal according to claim 10, wherein the profile of the first metallic layer and the profile of the further metallic layer are arranged at least partially offset with respect to each other.

13. The flat seal according to claim 1, wherein at least one of the metallic layers is produced from elastic spring steel.
